(19) United States
(12) Patent Application Publication
(10) Pub. No.: US 2019/0066527 A1
(43) Pub. Date: Feb. 28, 2019

(54) Systems, Methods, and Computer Program Products for Characterization of Grader Behaviors in Multi-Step Rubric-Based Assessments

(71) Applicant: East Carolina University, Greenville, NC (US)

(72) Inventor: Robert Todd Watkins, JR., Chapel Hill, NC (US)

(21) Appl. No.: 16/117,433

(22) Filed: Aug. 30, 2018

Related U.S. Application Data
(60) Provisional application No. 62/552,651, filed on Aug. 31, 2017.

(51) Int. Cl. G09B 5/12; G09B 7/02

(52) U.S. Cl. CPC G09B 5/12; G09B 7/02

(57) ABSTRACT

Systems, methods, and computer program products for characterizing grader behavior and evaluating student performance may include generating a rubric for assessing competency of a student, receiving a plurality of assessments of the competency of the student based on the rubric, creating an assessment comparison between respective ones of the plurality of assessments, based on the assessment comparison, creating characterizations of the plurality of assessments, and calculating a final assessment of the competency of the student based on the characterizations of the plurality of assessments.

### RELATED APPLICATION

This non-provisional patent application claims priority, under 35 U.S.C. § 119(e), to U.S. Provisional Application Ser. No. 62/552,651, filed Aug. 31, 2017, entitled “Systems, Methods, And Computer Program Products for Characterization of Grader Behaviors in Multi-Step Rubric-Based Assessments,” the disclosure of which is incorporated herein in its entirety by reference.

### FIELD OF THE INVENTION

The invention relates to systems, methods, and computer program products, and more specifically to educational assessment systems that can evaluate the performance of graders in multi-step rubric-based assessments.

### BACKGROUND

In academic environments, the evaluation of students can play a key role in determining both the overall competence of the student with respect to current studies as well as the student's ability to proceed further into other topics.

In some cases, however, the evaluation of the student is subjective. This can be especially true when the student is being evaluated on their performance of certain tasks. Such subjective grading can lead to discrepancies in the evaluation of a student from one grader to the next. This can make it difficult to compare a student's performance between different academic environments with different graders. It also can make it difficult to evaluate a cohort of students who may all be taking similar types of training, but being graded by different persons.

There remains a need for alternate evaluation systems that can accommodate the difference in grader behavior across a plurality of graders and grading behavior.

### SUMMARY

Various embodiments described herein provide methods, systems, and computer program products for calibrating ratings for student competency.

Pursuant to some embodiments of the present invention, a system for calibrating ratings for competency of a student may include a processor and a memory coupled to the processor and storing computer readable program code that when executed by the processor causes the processor to perform operations. The operations may include generating a rubric for assessing the competency of the student, where the rubric comprises a plurality of rubric steps, each rubric step comprising strata that identify levels of performance associated with performing the rubric step, receiving a first assessment from a first grader and a second assessment from a second grader, where the first assessment comprises first strata that assesses performance of the student, and where the second assessment comprises second strata that assess the performance of the student, comparing the first assessment to the second assessment to generate a first differential between the first strata and the second strata, calculating a final assessment of the student comprising final strata based on an average of the first strata and the second strata responsive to determining a number of rubric steps for which the first and second strata are in agreement is greater than an agreement threshold, receiving a self assessment from the student, where the self assessment comprises third strata that assesses the performance of the student, comparing the self assessment to the final assessment to generate a second differential between the final strata and the third strata, and adjusting the final assessment of the student based on the second differential.

Pursuant to still further embodiments of the present invention, a system for calibrating ratings for competency of a student may include a processor, and a memory coupled to the processor and storing computer readable program code that when executed by the processor causes the processor to perform operations. The operations may include generating a rubric for assessing the competency of the student, receiving a plurality of assessments of the competency of the student based on the rubric, creating an assessment comparison between respective ones of the plurality of assessments, based on the assessment comparison, creating characterizations of the plurality of assessments, and calculating a final assessment of the competency of the student based on the characterizations of the plurality of assessments.

In some embodiments, the plurality of assessments comprise one or more assessments from a plurality of different graders.

In some embodiments, the plurality of assessments comprise a self assessment of the competency of the student that is generated by the student.

In some embodiments, the operations further include creating a characterization of the self assessment based on the assessment comparison, and further calculating the final assessment of the competency of the student based on the characterization of the self assessment. In some embodiments, further calculating the final assessment of the competency of the student based on the characterization of the self assessment includes calculating a differential between the final assessment and the self assessment for respective rubric steps of the rubric, calculating a number of the rubric steps for which the final assessment and the self assessment are in agreement, comparing the number of the rubric steps for which the final assessment and the self assessment are in agreement to an agreement threshold to determine an assessment agreement, and modifying the final assessment of the competency of the student based on the assessment agreement.

In some embodiments, modifying the final assessment of the competency of the student based on the assessment agreement comprises increasing the final assessment responsive to a determination that the number of the rubric steps for which the final assessment and the self assessment are in agreement is greater than the agreement threshold.

In some embodiments, modifying the final assessment of the competency of the student based on the assessment agreement comprises decreasing the final assessment responsive to a determination that the number of the rubric steps for which the final assessment and the self assessment are in agreement is less than the agreement threshold.

In some embodiments, generating the rubric for assessing the competency of the student includes creating a plurality of rubric blocks associated with assessing the competency of the student, for each of the plurality of rubric blocks, creating one or more rubric steps associated with performing the rubric block, for respective ones of the one or more rubric steps, creating strata that identify levels of performance associated with performing the rubric step, establishing a number of graders to be used in evaluating performance of the rubric, and establishing an agreement threshold for the rubric that defines a number of rubric steps for which the number of graders must select the same strata so as to be considered as in agreement.

In some embodiments, creating the assessment comparison between respective ones of the plurality of assessments includes selecting at least two assessments of the plurality of assessments, calculating a differential between the at least two assessments for respective rubric steps of the rubric, calculating a number of rubric steps for which the at least two assessments are in agreement, and comparing the number of rubric steps for which the at least two assessments are in agreement to the agreement threshold to determine an assessment agreement.

In some embodiments, the at least two assessments are in agreement if the number of rubric steps for which the at least two assessments are in agreement is greater than the agreement threshold.

In some embodiments, creating the characterizations of the plurality of assessments includes calculating a cumulative assessment differential based on a sum of the respective differentials of the at least two assessments, and calculating a cumulative assessment differential quotient based on the cumulative assessment differential divided by the number of rubric steps.

In some embodiments, creating the characterizations of the plurality of assessments further includes responsive to determining the number of rubric steps for which the at least two assessments are in agreement is greater than the agreement threshold, classifying the at least two assessments as being in agreement if the cumulative assessment differential is zero.

In some embodiments, calculating the final assessment of the competency of the student based on the characterizations of the plurality of assessments comprises calculating the final assessment based on an average of the at least two assessments responsive to determining the number of rubric steps for which the at least two assessments are in agreement is greater than the agreement threshold.

In some embodiments, calculating the final assessment of the competency of the student based on the characterizations of the plurality of assessments comprises excluding one of the at least two assessments of the plurality of assessments from being used for calculation of the final assessment responsive to determining the number of rubric steps for which the at least two assessments are in agreement is less than the agreement threshold.

Pursuant to still further embodiments of the present invention, a method for calibrating ratings for competency of a student may include generating a rubric for assessing the competency of the student, receiving a plurality of assessments of the competency of the student based on the rubric, creating an assessment comparison between respective ones of the plurality of assessments, based on the assessment comparison, creating characterizations of the plurality of assessments, and calculating a final assessment of the competency of the student based on the characterizations of the plurality of assessments.

In some embodiments, the plurality of assessments comprise one or more assessments from a plurality of different graders.

In some embodiments, the plurality of assessments comprise a self assessment of the competency of the student that is generated by the student.

In some embodiments, the method may further include creating a characterization of the self assessment based on the assessment comparison, and further calculating the final assessment of the competency of the student based on the characterization of the self assessment.

In some embodiments, further calculating the final assessment of the competency of the student based on the characterization of the self assessment may include calculating a differential between the final assessment and the self assessment for respective rubric steps of the rubric, calculating a number of the rubric steps for which the final assessment and the self assessment are in agreement, comparing the number of the rubric steps for which the final assessment and the self assessment are in agreement to an agreement threshold to determine an assessment agreement, and modifying the final assessment of the competency of the student based on the assessment agreement.

In some embodiments, modifying the final assessment of the competency of the student based on the assessment agreement comprises increasing the final assessment responsive to a determination that the number of the rubric steps for which the final assessment and the self assessment are in agreement is greater than the agreement threshold.

In some embodiments, modifying the final assessment of the competency of the student based on the assessment agreement comprises decreasing the final assessment responsive to a determination that the number of the rubric steps for which the final assessment and the self assessment are in agreement is less than the agreement threshold.

In some embodiments, generating the rubric for assessing the competency of the student includes creating a plurality of rubric blocks associated with assessing the competency of the student, for each of the plurality of rubric blocks, creating one or more rubric steps associated with performing the rubric block, for respective ones of the one or more rubric steps, creating strata that identify levels of performance associated with performing the rubric step, establishing a number of graders to be used in evaluating performance of the rubric, and establishing an agreement threshold for the rubric that defines a number of rubric steps for which the number of graders must select the same strata so as to be considered as in agreement.

In some embodiments, creating the assessment comparison between respective ones of the plurality of assessments includes selecting at least two assessments of the plurality of assessments, calculating a differential between the at least two assessments for respective rubric steps of the rubric, calculating a number of rubric steps for which the at least two assessments are in agreement, and comparing the number of rubric steps for which the at least two assessments are in agreement to the agreement threshold to determine an assessment agreement.

In some embodiments, the at least two assessments are in agreement if the number of rubric steps for which the at least two assessments are in agreement is greater than the agreement threshold.

In some embodiments, creating the characterizations of the plurality of assessments includes calculating a cumulative assessment differential based on a sum of the respective differentials of the at least two assessments, and calculating a cumulative assessment differential quotient based on the cumulative assessment differential divided by the number of rubric steps.

In some embodiments, creating the characterizations of the plurality of assessments further includes responsive to determining the number of rubric steps for which the at least two assessments are in agreement is greater than the agreement threshold, classifying the at least two assessments as being in agreement if the cumulative assessment differential is zero.

In some embodiments, calculating the final assessment of the competency of the student based on the characterizations of the plurality of assessments comprises calculating the final assessment based on an average of the at least two assessments responsive to determining the number of rubric steps for which the at least two assessments are in agreement is greater than the agreement threshold.

In some embodiments, calculating the final assessment of the competency of the student based on the characterizations of the plurality of assessments comprises excluding one of the at least two assessments of the plurality of assessments from being used for calculation of the final assessment responsive to determining the number of rubric steps for which the at least two assessments are in agreement is less than the agreement threshold.

Pursuant to still further embodiments of the present invention, a computer program product for operating an electronic device may include a non-transitory computer readable storage medium having computer readable program code embodied in the medium that when executed by a processor causes the processor to perform the operations including generating a rubric for assessing competency of a student, receiving a plurality of assessments of the competency of the student based on the rubric, creating an assessment comparison between respective ones of the plurality of assessments, based on the assessment comparison, creating characterizations of the plurality of assessments, and calculating a final assessment of the competency of the student based on the characterizations of the plurality of assessments.

As will be appreciated by those of skill in the art in light of the above discussion, the present invention may be embodied as methods, systems and/or computer program products or combinations of same. In addition, it is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart that illustrates embodiments for evaluating the performance of graders in rubric-based assessments according to various embodiments described herein;

FIG. 2 is a flowchart that illustrates embodiments for creating a rubric according to various embodiments described herein;

FIG. 3 is example of a user interface for creating rubric blocks of a rubric according to various embodiments described herein;

FIG. 4 is an example of a user interface for creating a rubric step for the rubric block of FIG. 3 according to various embodiments described herein;

FIG. 5 is an example of the user interface of FIG. 3 after rubric steps have been created, according to various embodiments described herein;

FIG. 6 is an example of a user interface in which strata can be entered for individual rubric steps of a rubric block according to various embodiments described herein;

FIG. 7 is an example of a user interface in which example strata have been entered according to various embodiments described herein;

FIG. 8 is an example graphical user interface which may be used by a grader to enter an assessment according to a defined rubric according to various embodiments described herein;

FIG. 9 is a flowchart that illustrates embodiments for calculating assessment agreements for various graders according to various embodiments described herein;

FIG. 10 is a user interface displaying a comparison table which may be used to compare one or more graders according to various embodiments described herein;

FIG. 11 is a user interface that illustrates the comparison table of FIG. 10 in which the various fields have been filled in for the graders' assessments according to various embodiments described herein;

FIG. 12 is a user interface displaying a comparison table which may be used to compare one or more students' self-assessment according to various embodiments described herein;

FIG. 13 is a user interface displaying an example of a grade calibration report for a particular fictitious grader according to various embodiments described herein.

FIG. 14 is a user interface displaying an example of a scenario where a student self-assessment is being compared to a single grader according to various embodiments described herein;

FIG. 15 is a user interface displaying an example of a scenario where a student self-assessment is being compared to two assessments from two graders according to various embodiments described herein;

FIG. 16 is a user interface displaying an example of a scenario where a student self-assessment is being compared to two graders with an additional appeal utilizing a reference grader according to various embodiments described herein;

FIG. 17 is a block diagram of an assessment system according to various embodiments described herein.

FIGS. 18A-18I are tables illustrating comparisons between two graders to determine a grader characterization.

### DETAILED DESCRIPTION

The present invention will now be described more fully hereinafter with reference to the accompanying figures, in which preferred embodiments of the invention are shown. This invention may, however, be embodied in many different forms and should not be construed as limited to the embodiments set forth herein.

Like numbers refer to like elements throughout. Broken lines illustrate optional features or operations unless specified otherwise.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms first, second, etc. may be used herein to describe various elements, components, regions, features, steps, layers and/or sections, these elements, components, features, steps, regions, layers and/or sections should not be limited by these terms. These terms are only used to distinguish one element, component, feature, step, region, layer or section from another region, layer or section. Thus, a first element, component, region, layer, feature, step or section discussed below could be termed a second element, component, region, layer, feature, step or section without departing from the teachings of the various embodiments described herein. The sequence of operations (or steps) is not limited to the order presented in the claims or figures unless specifically indicated otherwise.

As will be appreciated by one skilled in the art, aspects of the various embodiments described herein may be illustrated and described herein in any of a number of patentable classes or context including any new and useful process, machine, manufacture, or composition of matter, or any new and useful improvement thereof. Accordingly, aspects of the various embodiments described herein may be implemented entirely hardware, entirely software (including firmware, resident software, micro-code, etc.) or combining software and hardware implementation that may all generally be referred to herein as a “circuit,” “module,” “component,” or “system.” Furthermore, aspects of the various embodiments described herein may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the various embodiments described herein may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHIP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the various embodiments described herein are described herein with reference to flowchart illustrations and/or block diagrams of methods, apparatus (systems) and computer program products according to the various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the various embodiments described herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The term “assessment rubric” or “rubric” refers to a qualitative assessment of subject performance based on pre-determined definitions of performance that are organized in a sequence of procedural rubric steps.

The term “rubric steps” refers to the presentation of sequential criteria that are used cumulatively to qualitatively evaluate overall performance of a skill and/or task. In some embodiments, the rubric steps may assist in identifying competency in the underlying skill and/or task. Multi-step rubrics have at least 2 steps that define success or failure for the overall rubric.

The term “rubric step strata” or “strata” refers to the qualitative definitions of performance within a respective step of a rubric. There can be as many strata within a rubric step that are appropriate to define various degrees of success or failure for the rubric step. There must be at least 2 strata for each rubric step. As used herein, “strata” is used to indicate both the singular and plural forms of the definitions of performance within a respective step of the rubric.

The term “rubric step strata definition” or “strata definition” refers to a written statement that explains the criteria used to define the performance of a skill and/or task with respect to the rubric step strata.

The term “rubric step points” refers to a numeric value associated with each rubric step in the rubric.

The term “step agreement” refers to an agreement that occurs when two different graders select the same strata on the same rubric step in a rubric to assess a subject's performance as defined by the strata definition.

The term “step disagreement” refers to a disagreement that occurs when two different graders select different strata on the same rubric step in a rubric to assess a subject's performance as defined by the strata definition.

The term “assessment agreement threshold” or “agreement threshold,” in a multi-step assessment, refers to the percentage of steps that are required to be in agreement to define a threshold. As an example, if a rubric has four rubric steps, an agreement threshold of 75% may be met when 3 of the 4 rubric steps are in step agreement between two different graders.

The term “inter-grader/rater assessment comparison” or “assessment comparison” refers to when the strata of all rubric steps for two different graders/raters are compared and recorded with a binary result (e.g., 1 for “agreement” and 0 for “disagreement”). The percentage of rubric steps in step agreement as compared to the total rubric steps may be calculated and recorded. The percentage of step agreement may be compared to the assessment agreement threshold.

The term “inter-grader/rater step differential calculation” or “step differential calculation” refers to the subtraction of the strata number chosen by a lower calibrated grader (minuend) from the strata number chosen by a higher calibrated grader (subtrahend) to yield a mathematical difference.

The term “inter-grader/rater step designation” or “step designation” refers to the location where the step differential calculation is reported.

The term “grader/rater” refers to any individual who evaluates an intended subject's skill, competency and/or educational performance. Note that this can include the subject him/herself in the form of a self-assessment. The terms “grader,” “rater,” and “grader/rater” are used interchangeably herein.

The term “subject” refers to the person being evaluated using the assessment rubric.

The term “grader/rater 1,” in a multi-grader assessment, refers to the first grader to evaluate the subject using the assessment rubric. As a practical matter, different individuals can be included into the grader/rater 1 role in the same assessment.

The term “grader/rater 2,” in a multi-grader assessment, refers to the grader who evaluates the subject following the grader 1 using the assessment rubric. There can be more than one grader 2. In a 2-grader assessment, the grader 2 may be further defined to be the “reference grader.” As the reference grader, the grader 2 evaluation may be deemed to be correct and his/her evaluation may be chosen as the “correct” evaluation and the grader 1 evaluation may be eliminated.

The term “definitive grader,” in a multi-grader assessment, refers to the grader that evaluates the subject when the grader 1 and reference grader are not in step agreement on a sufficient number of rubric steps to meet the pre-determined agreement threshold.

The term “grader/rater qualification” refers to a rule definition that includes the evaluation by a grader/rater when the number of strata in step agreement with another grader/rater satisfies the assessment agreement threshold. This means that the points from this assessment may be included in the final subject grade.

The term “grader/rater disqualification” refers to a rule definition that removes the evaluation by a grader/rater when the number of strata in step agreement with another grader/rater does not satisfy the assessment agreement threshold. This may mean that the points from this assessment are not included in the final subject grade.

The term “final grade calculation” refers to a rule that includes the points from all strata in step agreement and averages the points from all strata not in step agreement for all strata for all graders whose evaluations are included in the assessment (e.g., without graders/raters who have been disqualified).

The term “final strata calculation” refers to a rule that matches the points from all strata in agreement and performs a best match for the averaged points from all strata not in agreement for all strata for all graders whose evaluations are included in the assessment (e.g., without graders/raters who have been disqualified). The best match may be based on the numeric closest proximity of the averaged points to the point definitions of the original strata.

As recognized and addressed by the embodiments described herein, there is a need for an ability to normalize grades related to a student's competency that are received from a plurality of different graders. Similarly, as recognized and addressed by the embodiments described herein, there is a need for an ability to recognize whether a student is capable of performing an accurate self-assessment of their own abilities.

Embodiments described herein utilize a multi-phase analysis approach to provide a normalization and/or comparison between different graders. The comparison described herein also allows for the identification of significant deviations from a reference grading position, as well as the ability to compare a student's self-assessments to the grader positions. These methods, systems, and computer program products described herein can promote technical efficiency within the grading process. For example, the analysis described herein can automatically identify discrepancies between graders, and additionally characterize the discrepancy, in a way that allows for the evaluation to be automatically adjusted without requiring a regrade. Moreover, the methods, systems, and computer program products described herein can provide an analytical trail that allows for comparison of grading procedures over a long period of time, and across a number of students. Such methods, systems, and computer program products can provide accountability to the grading process, improve efficiency in student evaluation, and/or increase the awareness of differences between different graders in assessing similar subjects, thus assisting in the evaluation of the validity of the assessment.

The same or similar process may be used for evaluating the inter-grader assessments as well as student self-assessment, and the evaluation of student self-assessment may be required by most accreditation bodies as part of problem solving and critical thinking. A rubric may assess the student skill and/or competency itself, and the inter-grader evaluation of student self-assessment may evaluate whether the student understands how poorly or well they are performing. In some embodiments, the self-assessment of the student may be used to adjust the grader evaluation depending on whether the self-assessment is concordant or discordant with the grader's evaluation. For example, if the self-assessment is discordant from and/or differs from the final evaluation by more than a predetermined threshold, the grader evaluation may be adjusted (e.g., downwards). This may cause a respective student to be more readily introspective and/or aware of his/her actual ability/performance and can provide valuable life “feedback” as a reality check on future independent work. Thus, the self-assessment may help emphasize the ability to accurately assess one's own performance.

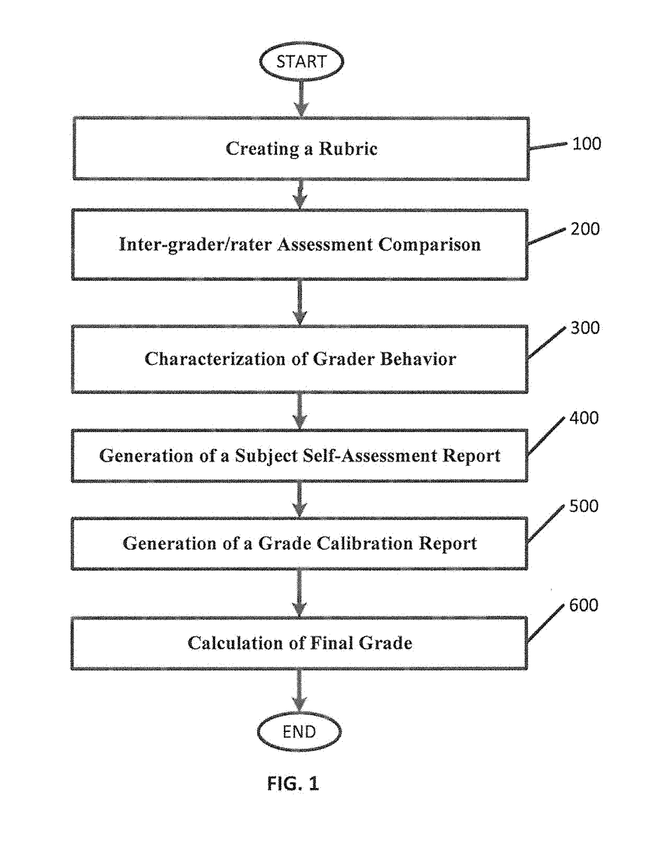

FIG. 1 is a flowchart that illustrates embodiments for evaluating the performance of graders in rubric-based assessments according to various embodiments described herein. As illustrated in FIG. 1, methods, systems, and computer program products for evaluating the performance of graders in rubric-based assessments may include a plurality of operations: creating a rubric (block 100), inter-grader/rater assessment comparison (block 200), characterization of grader behavior (block 300), generation of a subject self-assessment report (block 400), generation of a grade calibration report (block 500), and calculation of a final grade (block 600).

Creating a Rubric

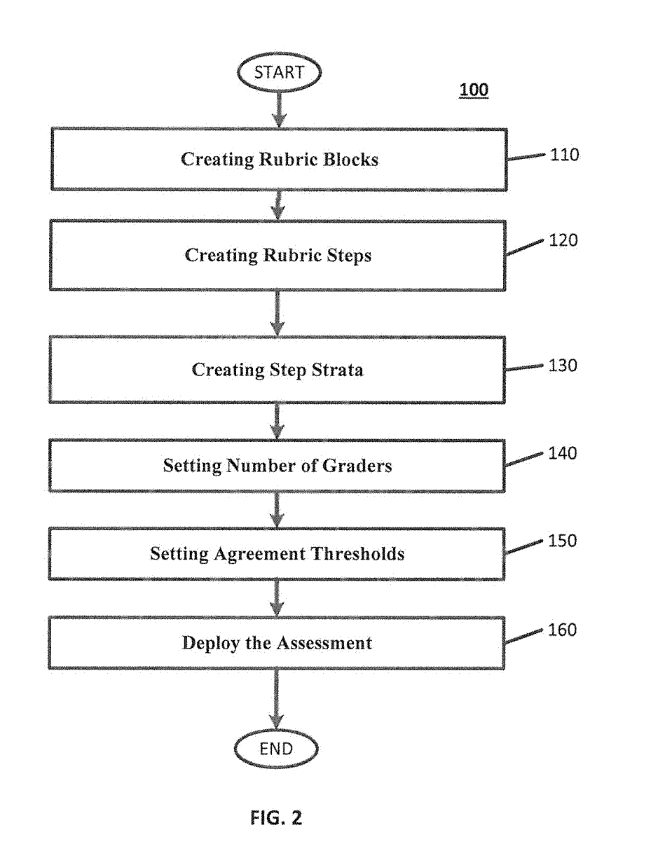

Methods, systems, and computer program products described herein may include creating a rubric (block 100). FIG. 2 is a flowchart that illustrates embodiments for creating a rubric according to various embodiments described herein. As illustrated in FIG. 2, creating a rubric may include additional sub-operations (block 110, 120, 130, 140, 150, and 160), as described further herein.

Creating Rubric Blocks

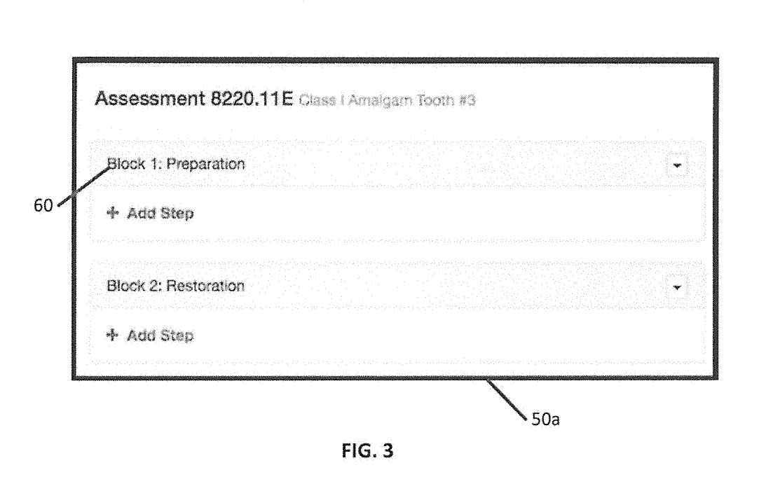

It is possible for a complex rubric to include multiple “rubric blocks,” that may be created as an initial step in creating the rubric (FIG. 2, block 110). Rubric blocks may be created (block 110) to group related rubric steps when a task, assignment and/or skill is sufficiently complex as to require successful completion of one component before the subject can proceed to a next component. FIG. 3 illustrates an example of such rubric blocks. FIG. 3 illustrates an example of a user interface 50a for creating rubric blocks 60 of a rubric according to various embodiments described herein. As illustrated in FIG. 3, the user interface 50a may display two rubric blocks 60 for a rubric assessing procedures associated with an amalgam tooth, one rubric block for “Preparation” and one rubric block for “Restoration.” The rubric blocks 60 illustrated in FIG. 3 are merely examples, and different types of rubric blocks 60, as well as different numbers of rubric blocks 60, may be created without deviating from the various embodiments described herein.

Creating Rubric Steps

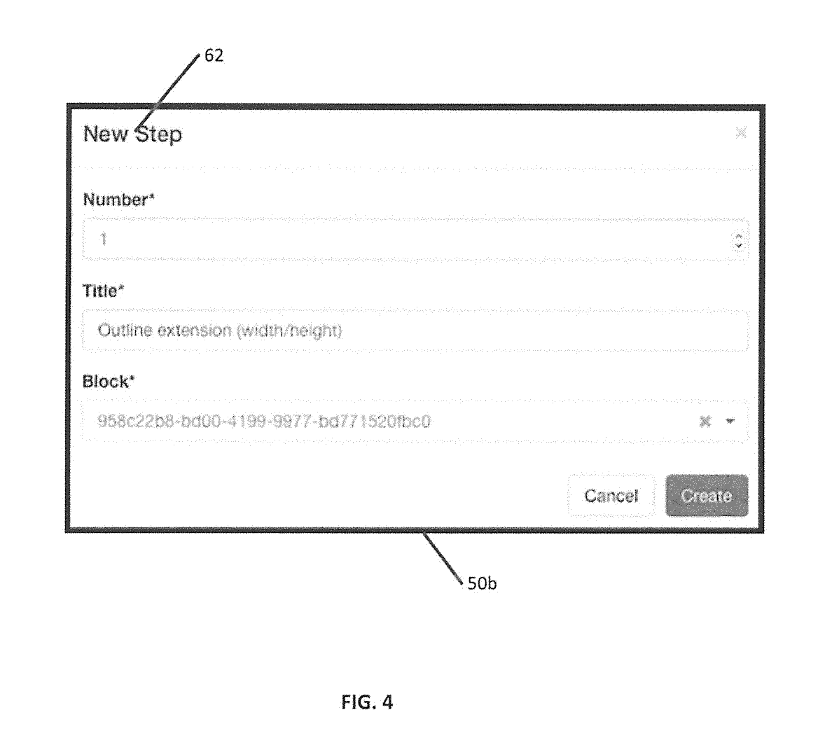

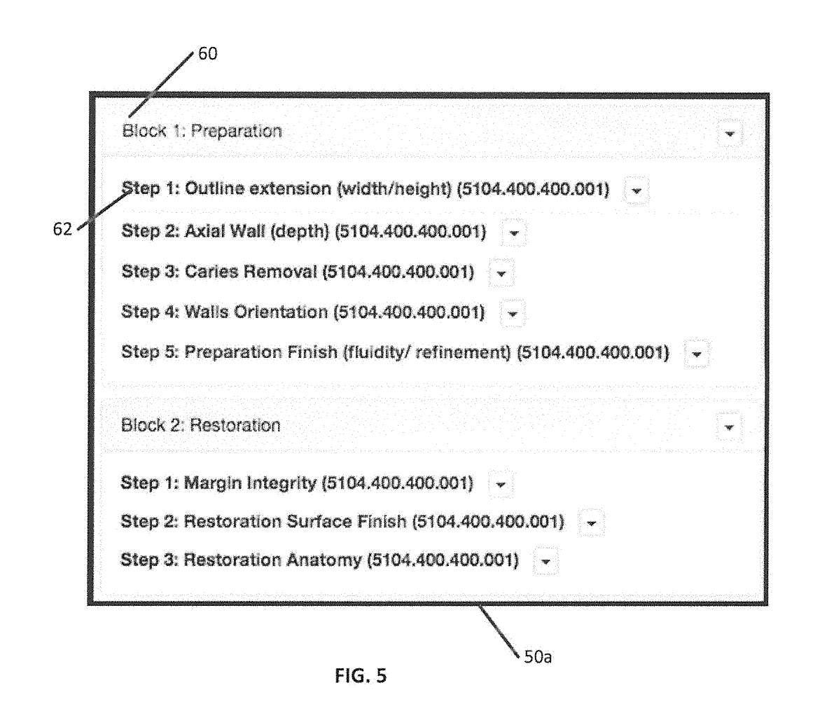

The organization structure of a rubric includes a rubric step, which may be grouped in one or more rubric blocks. After creating a rubric block, one or more individual rubric steps may be created (FIG. 2, block 120). Each rubric step may be numbered sequentially, may be titled, and may be associated with a rubric block. FIG. 4 illustrates an example of a user interface 50b for creating a rubric step 62 for the rubric block 60 of FIG. 3 according to various embodiments described herein. As illustrated in FIG. 4, the user interface 50b may provide mechanisms for the input and description of a new rubric step 62. For example the user interface 50b may allow for the input of a number (e.g., a numeric order) for the rubric step, a tile, and an identification of a rubric block to which the rubric step belongs. FIG. 5 illustrates an example of the user interface 50a of FIG. 3 after rubric steps 62 have been created, according to various embodiments described herein. In some embodiments, the rubric blocks and steps may be saved in a database for storage and/or reuse. As illustrated in FIG. 5, the saved rubric steps 62 are displayed in the user interface 50a of FIG. 3 with a sequential number and a title within an associated rubric block 60. As will be understood by one of skill in the art, the rubric steps 62 may be specific to the overall rubric being created, and different rubrics may involve different rubric steps 62. The rubric steps 62 in FIGS. 4 and 5 are examples, and the present embodiments are not limited thereto.

Creating Step Strata

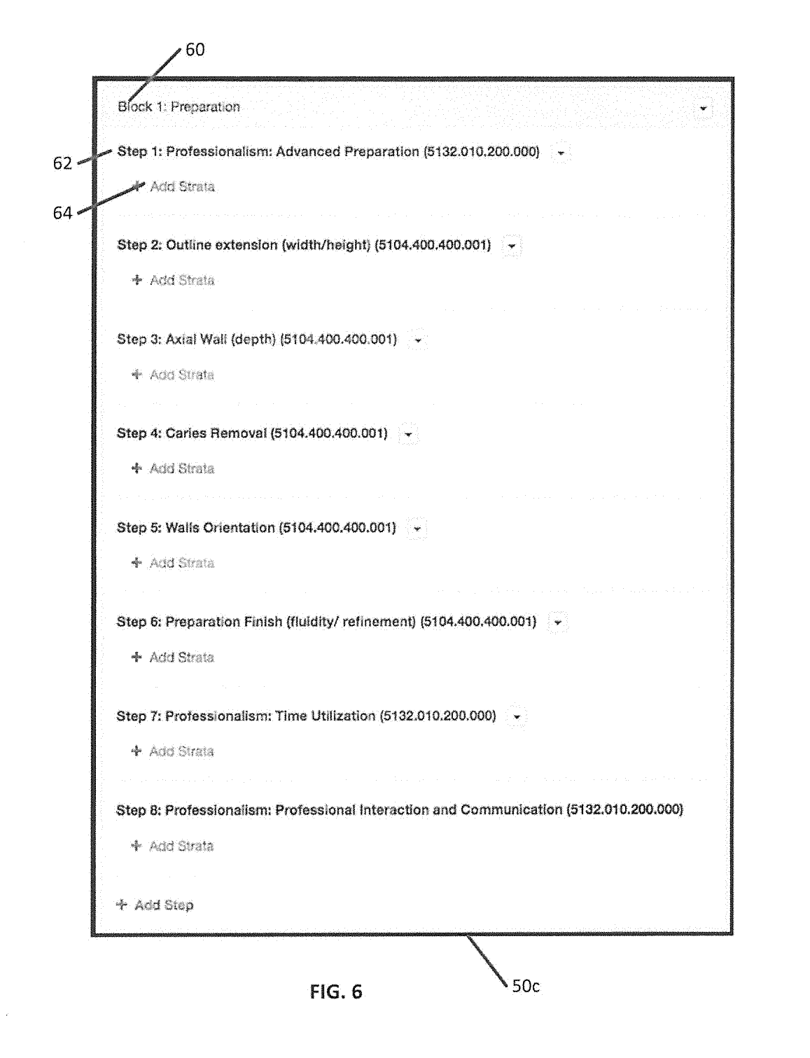

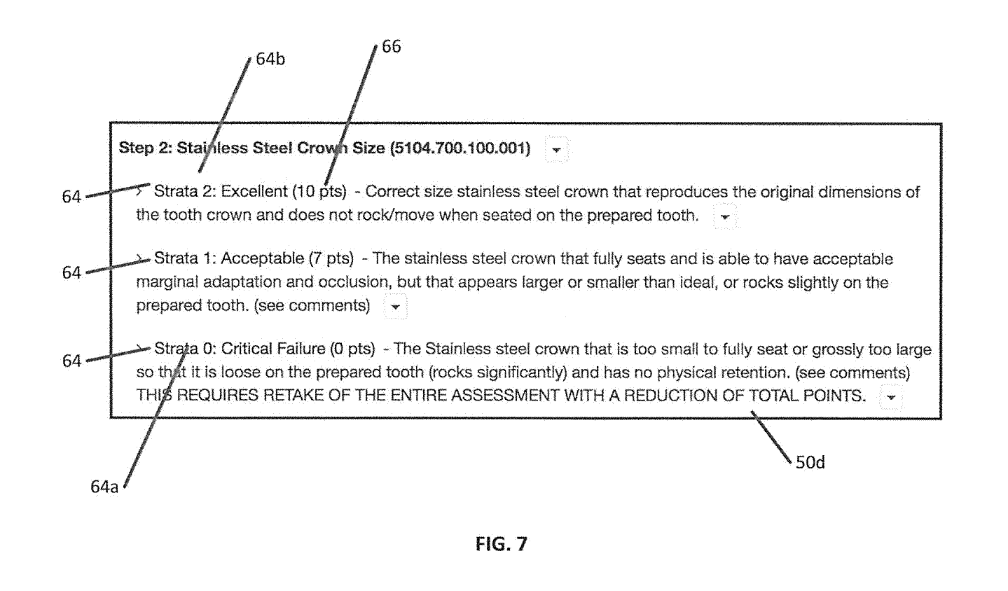

Strata are the hierarchical definitions of the quality of the performance of the subject for a rubric step. The step strata may be created and/or associated with a particular rubric step (FIG. 2, block 130.). FIG. 6 illustrates an example of a user interface 50c in which strata 64 can be entered for individual rubric steps 62 of a rubric block 60 according to various embodiments described herein. The strata 64 may be built from the bottom up. In some embodiments, the rubric strata may be saved in a database for storage and/or reuse. FIG. 7 illustrates an example of a user interface 50d in which example strata 64 have been entered according to various embodiments described herein. For example, first, there may be failure strata 64a shown at the bottom of the strata 64. The failure strata 64a may define what level of skill is inadequate to pass the rubric step. Second, the passing/acceptable levels 64b of performance may be defined in gradations. It may be possible to make this strata binary (e.g., pass versus fail) or to give more subtle gradations of strata. As is illustrated in FIG. 7, different gradations of strata 64 have been entered, with one failure strata 64a (Critical Failure) and two passing strata (Excellent and Acceptable) 64b. For every strata 64 there may be a written definition of the performance standard associated with the grader selection of that strata 64. Also, there may be an associated point value 66 for each strata 64. This is useful for final grade calculation and final strata calculation. Once the strata 64 are defined for all rubric steps in all rubric blocks, the rubric is complete.

Setting Number of Graders

Next, the number of graders/raters may be assigned (FIG. 2, block 140). There are at least two choices with various levels of complexity with respect to setting the number of graders. In the first choice, the rubric can be designated as a multi-grader rubric (e.g., a 2-grader rubric). For example, this may mean that each student may be evaluated by two different independent graders. There can be multiple people assigned to one of the two roles. Grader 1 and grader 2 roles may be assigned to specific graders. In some embodiments, the grader 2 may be the “reference grader.” In the event of an assessment disagreement between grader 1 and grader 2, grader 2 may be considered to be the better grader and his/her evaluation may be chosen as being “correct.” In such a case, the grader 1 evaluation may be disqualified.

In the second choice, the rubric can be designated as a multi-grader (e.g., a 2-grader) with appeal rubric. For example, this may mean that each student will be evaluated by at least 2 graders. The difference for this designation is that, in the event that grader 1 and grader 2 are in disagreement, then a third grader, known as the definitive grader, may also independently evaluate the student. The results of grader 1 and grader 2 may both be evaluated with the grader 3 results. The final grade may be calculated based on the inter-rater comparisons relative to the agreement thresholds, as described herein.

Setting Agreement Thresholds

An agreement threshold may be determined (FIG. 2, block 150). The agreement threshold may represent the number of the rubric steps (within a rubric block) for which the graders must select the same strata to be considered as being in agreement. In some embodiments, the agreement threshold may be represented as a percentage.

Deploy the Assessment

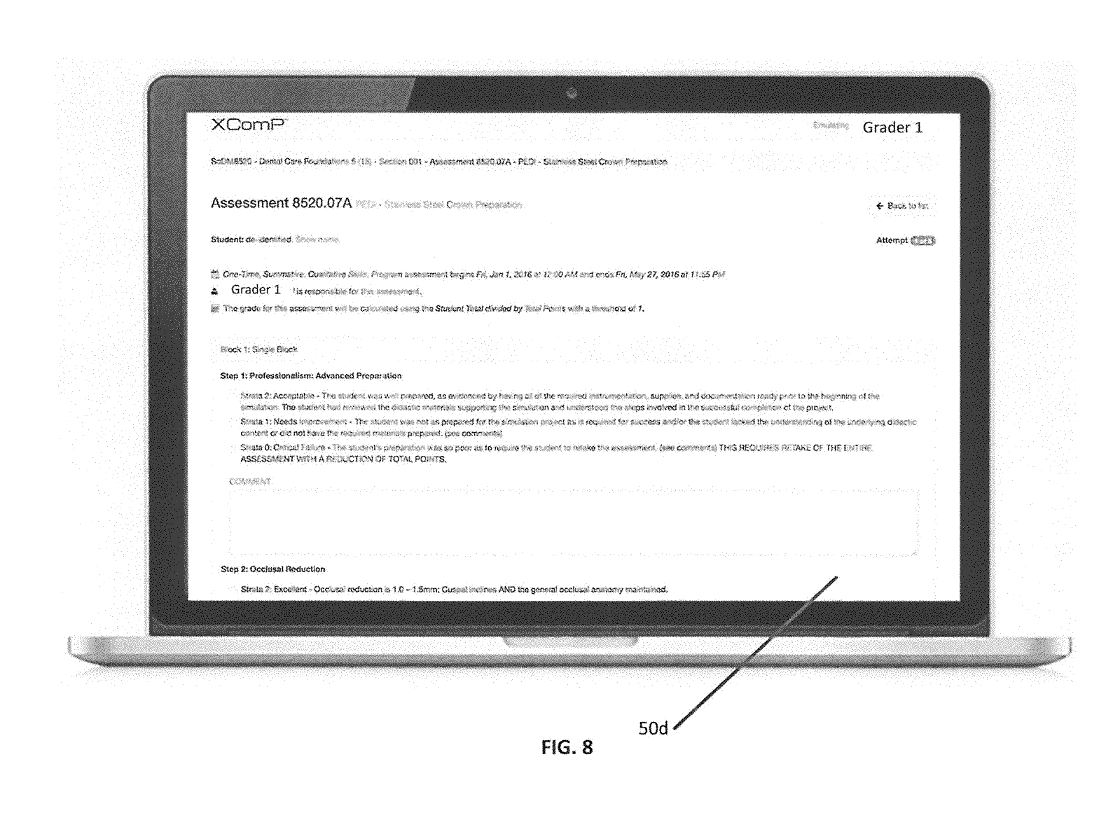

The assessment may be deployed (FIG. 2, block 160). For example, the assessment may be used to evaluate a student's performance of a task, assignment, and/or skill. The graders may interface with the assessment by choosing the desired strata for the respective rubric steps of the rubric with an input element (e.g., a radio button in a graphical user interface). In some embodiments, the grader may additionally enter comments per rubric step. FIG. 8 illustrates a sample graphical user interface 50d which may be used by a grader to enter an assessment according to a defined rubric. As illustrated in FIG. 8, the strata presented in the graphical user interface by reflect the strata previously created (FIG. 2, block 130). The graphical user interface 50d may be accessed by graders previously identified (FIG. 2, block 140).

Inter-Grader/Rater Assessment Comparison

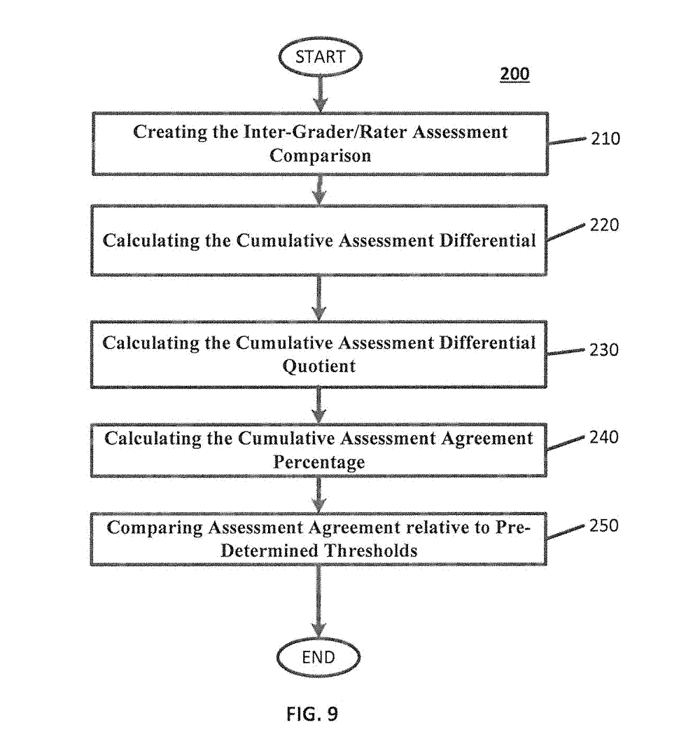

Referring again to FIG. 1, Methods, systems, and computer program products described herein may include comparing assessments between designated graders. (FIG. 1, block 200). FIG. 9 illustrates embodiments for calculating assessment agreements for various graders according to various embodiments described herein. As illustrated in FIG. 9, comparing graders may include additional sub-operations (blocks 210, 220, 230, 240, 250), as described further herein.

Creating the Inter-Grader/Rater Assessment Comparison

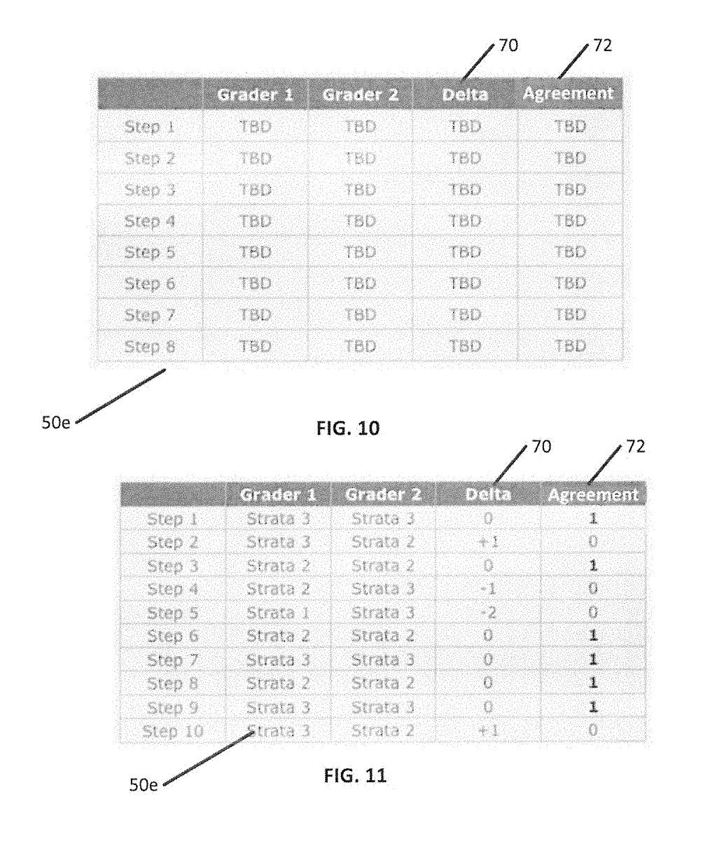

Referring to FIG. 9, an inter-grader/rater assessment comparison may be created (FIG. 9, block 210). When setting up the assessment comparisons between two graders, it may be useful to establish a hierarchy of the graders themselves. The evaluation from the more senior grader may be subtracted from the evaluation of the less senior grader. For example, in some embodiments, the grader 2 evaluation may be subtracted from the grader 1 evaluation for each rubric step. In some embodiments, grader 1 and/or grader 2 evaluations may be subtracted from the definitive grader evaluation for each rubric step in an appeal or overview process. The final grade may be subtracted from the subject self-assessment. FIG. 10 illustrates a user interface 50e displaying a comparison table which may be used to compare one or more graders according to various embodiments described herein As illustrated in FIG. 10, each grader may have a column containing that grader's strata selection for the rubric steps of the assessment rubric. There may also be a column 70 to record a delta value indicating a different between the strata selection of the graders. There may also be an Agreement column 72 indicating whether the graders are in agreement. For example, a ‘1’ may be assigned to the Agreement column 72 when the two graders are in agreement, and a ‘0’ may be assigned to the Agreement column 72 when the two graders are not in agreement. The agreement may be based on the delta value between the two grader strata selections. The cumulative number of steps for which the two graders are in agreement (e.g., 6 in FIG. 11) may be divided by the total number of steps in the rubric to see how often the two graders agree (e.g., 6/10 or 60% in FIG. 11). The delta by which the strata selected by the graders differ and the percentage of steps in agreement between the graders may both contribute to the characterization of the graders.

FIG. 11 illustrates a user interface 50e displaying the comparison table of FIG. 10 in which the various fields have been filled in for the graders' assessments according to various embodiments described herein. As illustrated in FIG. 11, there may be ten rubric steps in the rubric block with a plurality of strata per rubric step. Strata 0 may be a critical failure, which may be standard for all rubric steps, and strata 1, 2, and 3 may be defined as acceptable performance. In some embodiments, if grader 1 and/or grader 2 select Strata 0 (critical failure) on any rubric step and the other grader does not select Strata 0, then the assessment is automatically considered to be discordant or in disagreement. A ‘1’ may be assigned as the Agreement value (see Agreement column 72) for a step that designated as being discordant or in disagreement. In some embodiments, if both graders select the same strata, the differential (delta) is 0 and that step may be designated as being concordant or in agreement. A ‘1’ may be assigned as the Agreement value for a step that designated as being concordant or in agreement. In FIG. 11, Step 1 is an example of such an agreement. In some embodiments, if grader 1 selects a higher strata than the grader 2, then the differential (delta) is a positive number (e.g., grader 2 is subtracted from grader 1) and the rubric step may be designated as being discordant or in disagreement. In FIG. 11, Step 2 is an example of such a disagreement. In some embodiments, if grader 1 selects a lower strata than the grader 2, then the differential (delta) is a negative number e.g., grader 2 is subtracted from grader 1) and the step may be designated as being in disagreement. In FIG. 11, Step 4 is an example of such a disagreement. As used herein, subtracting one strata from another refers to subtracting a first numeric value for a first rubric strata (e.g., the number 3 for Strata 3) from a second numeric value for a second rubric strata (e.g., the number 2 for Strata 2) to develop a delta (e.g., a delta of −1). In some embodiments, the numeric value assigned rubric strata may increase with respect to a level of competence associated with the rubric step. For example, a rubric strata that indicates a higher level of competence (e.g., “excellent” vs. “acceptable”) may have a higher numeric value, though the embodiments described herein are not limited thereto. In some embodiments, a rubric strata that indicates a higher level of competence may have a lower numeric value.

Calculating the Cumulative Assessment Differential

A cumulative assessment differential may be determined (FIG. 9, block 220). After all strata are compared for all rubric steps in the rubric, and the differential is determined for all rubric steps in the assessment, then all of the differential differences for all rubric steps are summed to yield an assessment differential number. In the example of FIG. 11, the sum of all of the differentials for all steps (delta column) is equal to −1.

Calculating the Cumulative Assessment Differential Quotient

The cumulative assessment differential previously determined (FIG. 9, block 220) may be divided by the total number of steps to yield a percentage (FIG. 9, block 230). In the example of FIG. 11, the cumulative assessment differential quotient is −0.1 (e.g., −1 divided by 10).

Calculating the Cumulative Assessment Agreement Percentage

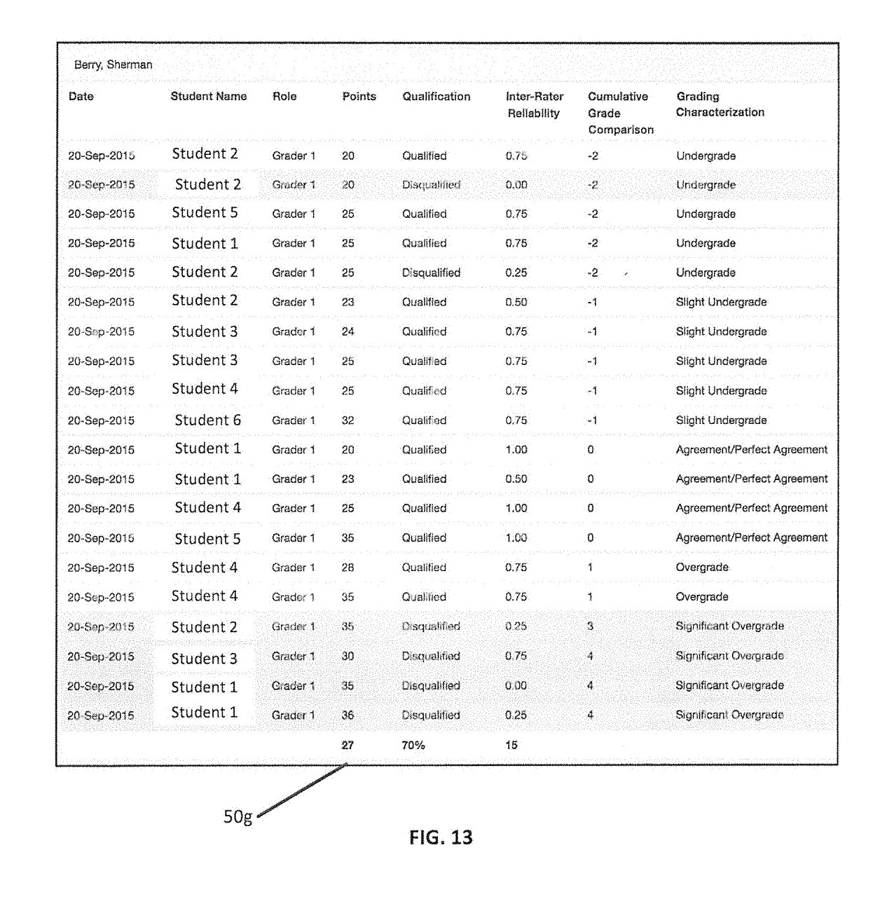

A cumulative assessment agreement percentage may be calculated (FIG. 9, block 240). After all strata are compared for all rubric steps in the rubric, a 1 may be assigned to all rubric steps where the differential is equal to 0 (e.g., the graders are concordant or in agreement) and a 0 may be assigned to all rubric steps where the differential is not equal to 0 (e.g., the graders are discordant or in disagreement). These are illustrated in FIG. 11 within the Agreement column 72. The number of rubric steps that are in agreement may be divided by the number of rubric steps in the rubric to yield a percentage. In the example of FIG. 11, 6 of the 10 steps are in agreement, yielding a 60% agreement percentage. In some embodiments, the agreement may be also illustrated as a decimal value based on the percentage (e.g., 0.6 for 60% agreement, 1.00 for 100% agreement). The agreement percentage may also be known as the IRR value for the assessment (see, e.g., FIG. 13).

Comparing Assessment Agreement Relative to Pre-Determined Thresholds

The cumulative assessment agreement percentage previously determined (FIG. 9, block 240) may be compared (FIG. 9, block 250) to the previously-determined agreement threshold (e.g., FIG. 2, 150). If, for example, the threshold had been set to 70%, the assessment of the rubric block and its rubric stems (i.e., ten) illustrated in the example of FIG. 11 would be in disagreement. If, for example, the threshold had been set to 60%, the assessment in the example of FIG. 11 would be in agreement.

Characterization of Grader Behavior

Referring back to FIG. 1, methods, systems, and computer program products described herein may include may include characterizing the behavior of the designated graders. (FIG. 1, block 300) This characterization may be based, for example, on data that has been previously determined (e.g., via the process illustrated in FIG. 9).

Once the cumulative assessment differential quotient (FIG. 9, block 230) and assessment agreement percentage (FIG. 9, block 240) for each comparison of a rubric block is generated, a characterization for the grader behavior can be made. The characterizations can indicate a relative magnitude of a difference between one or more graders. Example grader characterizations are agreement/perfect agreement, equivocal, slight undergrade, undergrade, significant undergrade, slight overgrade, overgrade, and/or significant overgrade.

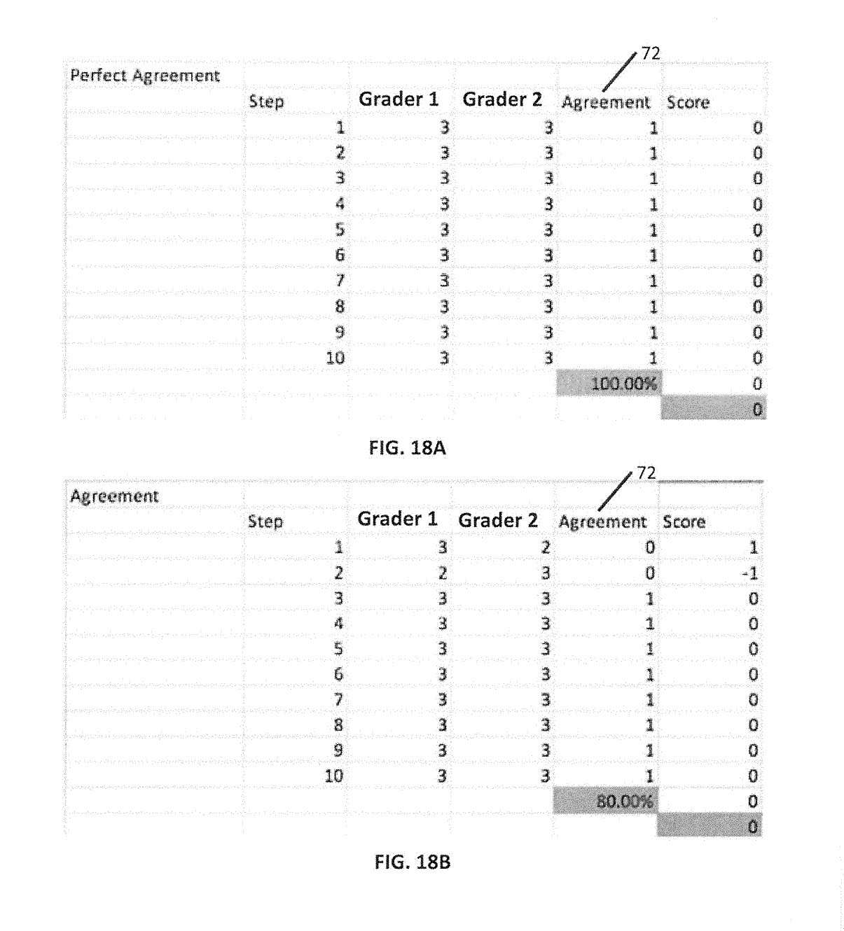

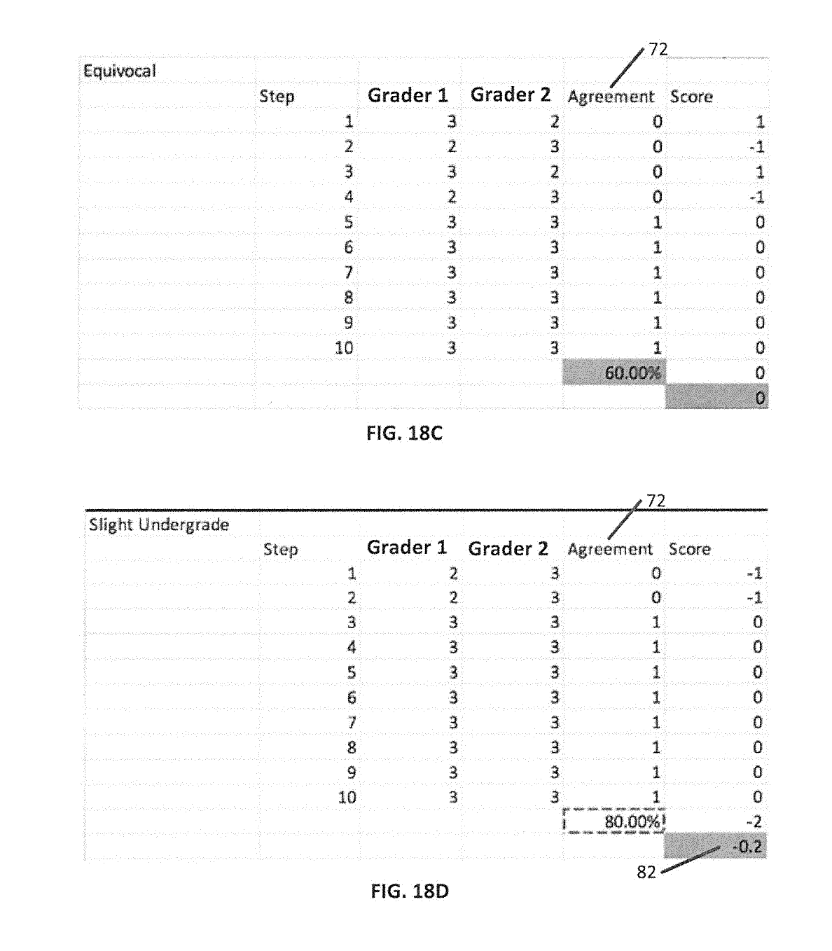

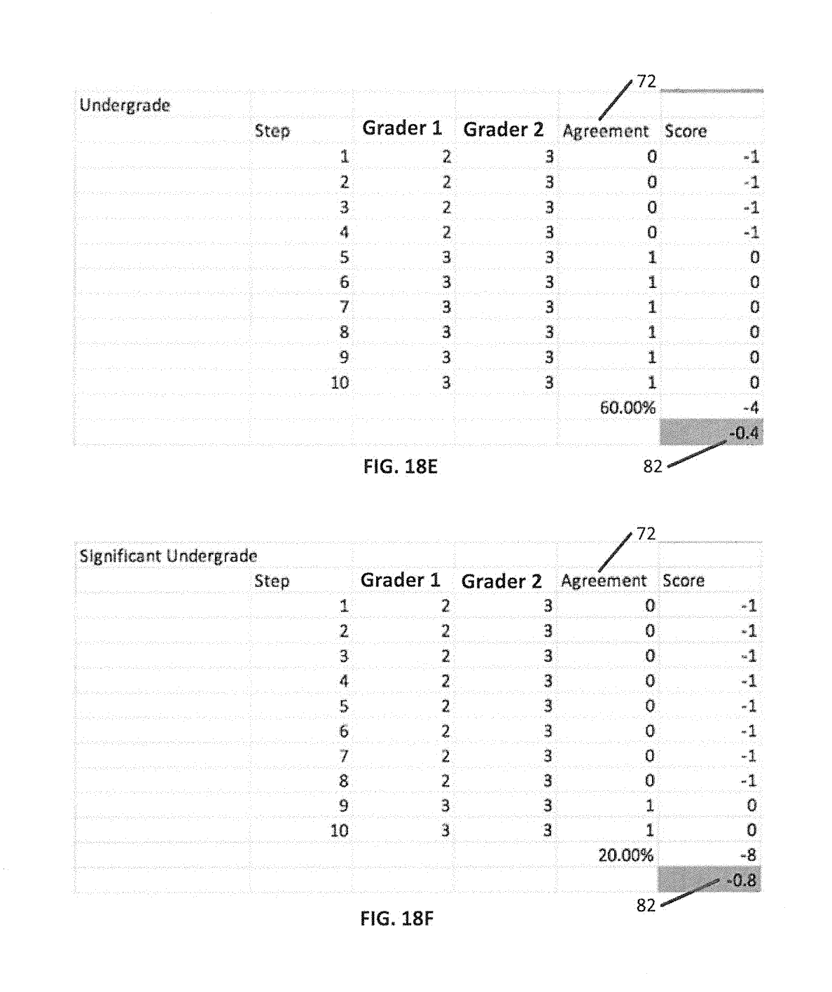

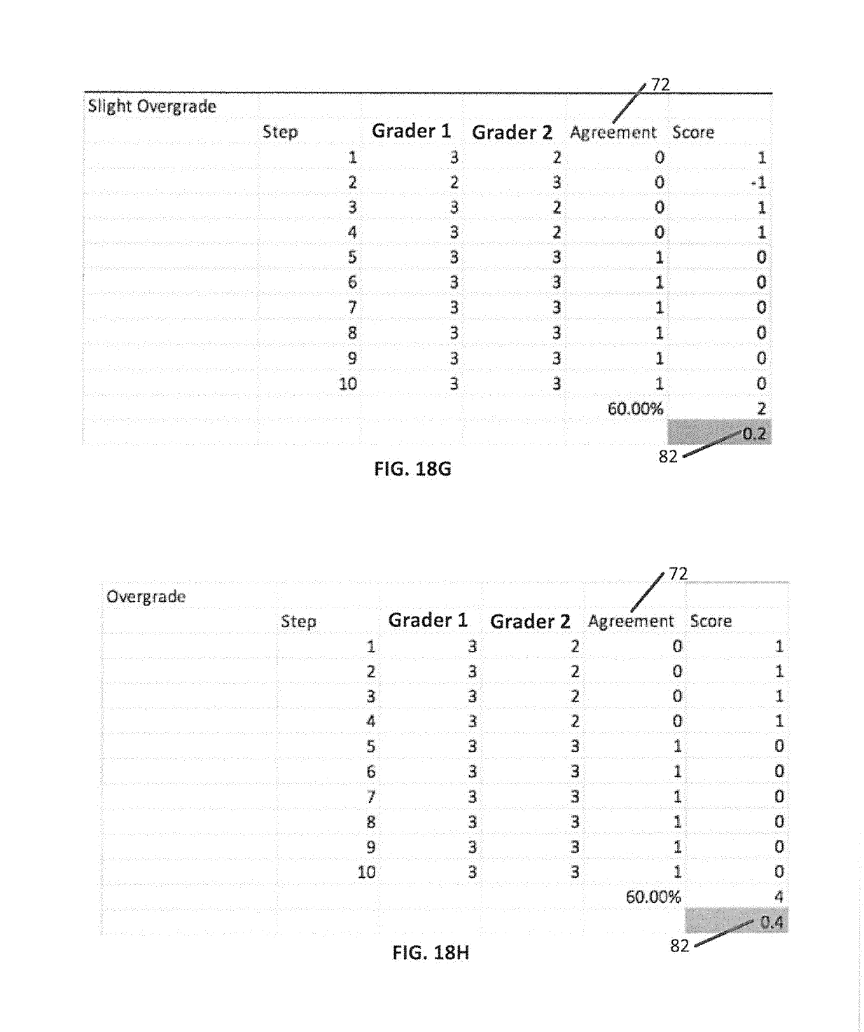

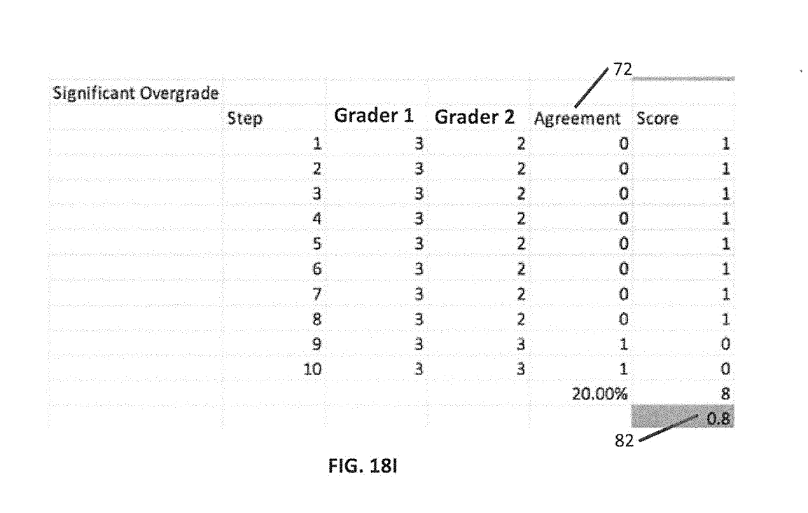

Perfect Agreement: This characterization may be defined when the cumulative assessment agreement percentage is zero, and the cumulative assessment differential is also zero. For example, “Perfect Agreement” may occur when all of the rubric steps for both graders are identical. Referring to FIG. 11, Perfect Agreement may occur when there are all ‘1’ values in the Agreement column 72, and the cumulative assessment differential is equal to 0. FIG. 18A illustrates an example in which the selections of two graders (illustrated as Grader 1 and Grader 2) are compared and found to be in Perfect Agreement. As illustrated in the Agreement column 72, the graders have made the same selections for each of the rubric steps.

Agreement: This characterization may be defined when the cumulative assessment differential is zero and the cumulative assessment agreement percentage is greater than or equal to the previously-determined predetermined threshold (e.g., 70%). FIG. 18B illustrates an example in which the selections of two graders (illustrated as Grader 1 and Grader 2) are compared and found to be in Agreement. As illustrated in the Agreement column 72, the graders are not in perfect agreement for each of the rubric steps (they disagreed on two rubric steps), but the cumulative assessment agreement percentage is 80%, indicating that the two graders agreed on a significant number of rubric steps.

Equivocal: This characterization may be defined when the cumulative assessment differential is zero and the cumulative assessment agreement percentage is less than the previously-determined predetermined threshold (e.g., 70%). For example, this characterization may occur when the two graders disagree on many steps but the overgrading and undergrading differentials cancel each other out, yielding a 0. Essentially, the lower grader may be guessing. FIG. 18C illustrates an example in which the selections of two graders (illustrated as Grader 1 and Grader 2) are compared and found to be Equivocal, with a cumulative assessment agreement percentage of 60%.

Slight Undergrade: This characterization may be defined when the cumulative assessment differential quotient is between greater than zero and a first negative level (e.g., between greater than 0 and about −0.25). FIG. 18D illustrates an example in which the selections of two graders (illustrated as Grader 1 and Grader 2) are compared and found to have a Slight Undergrade. As illustrated in FIG. 18D, the comparison between the two graders has resulted in a cumulative assessment differential quotient 82 of −0.2.

Undergrade: This characterization may be defined when the cumulative assessment differential quotient is between the first negative level and a second negative level (e.g., between about −0.25 and about −0.75). FIG. 18E illustrates an example in which the selections of two graders (illustrated as Grader 1 and Grader 2) are compared and found to have an Undergrade. As illustrated in FIG. 18E, the comparison between the two graders has resulted in a cumulative assessment differential quotient 82 of −0.4.

Significant Undergrade: This characterization may be defined when the cumulative assessment differential quotient is less than the second negative level (e.g., less than about −0.75). FIG. 18F illustrates an example in which the selections of two graders (illustrated as Grader 1 and Grader 2) are compared and found to have a Significant Undergrade. As illustrated in FIG. 18F, the comparison between the two graders has resulted in a cumulative assessment differential quotient 82 of −0.8.

Slight Overgrade: This characterization may be defined when the cumulative assessment differential quotient is between greater than zero and a first positive level (e.g., between greater than zero and about 0.25). FIG. 18G illustrates an example in which the selections of two graders (illustrated as Grader 1 and Grader 2) are compared and found to have a Slight Overgrade. As illustrated in FIG. 18G, the comparison between the two graders has resulted in a cumulative assessment differential quotient 82 of 0.2.

Overgrade: This characterization may be defined when the cumulative assessment differential quotient is between the first positive level and a second positive level (e.g., between about 0.25. and about 0.75). FIG. 18H illustrates an example in which the selections of two graders (illustrated as Grader 1 and Grader 2) are compared and found to have an Overgrade. As illustrated in FIG. 18H, the comparison between the two graders has resulted in a cumulative assessment differential quotient 82 of 0.4.

Significant Overgrade: This characterization may be defined when the cumulative assessment differential quotient is greater than the second positive level (e.g., greater than about 0.75). FIG. 18I illustrates an example in which the selections of two graders (illustrated as Grader 1 and Grader 2) are compared and found to have a Significant Overgrade. As illustrated in FIG. 18I, the comparison between the two graders has resulted in a cumulative assessment differential quotient 82 of 0.8.

As noted above, the grader characterization may utilize various different values for the cumulative assessment differential quotient and/or assessment agreement. It will be understood that these values are representative values, and that other values (e.g., for the first negative level, second negative level, first positive level, and second positive level) could be chosen to define the various characterization levels without deviating from the scope and spirit of the present invention. Similarly, more or fewer characterizations could be defined to create different levels of granularity in the characterizations.

Subject Self-Assessment Report

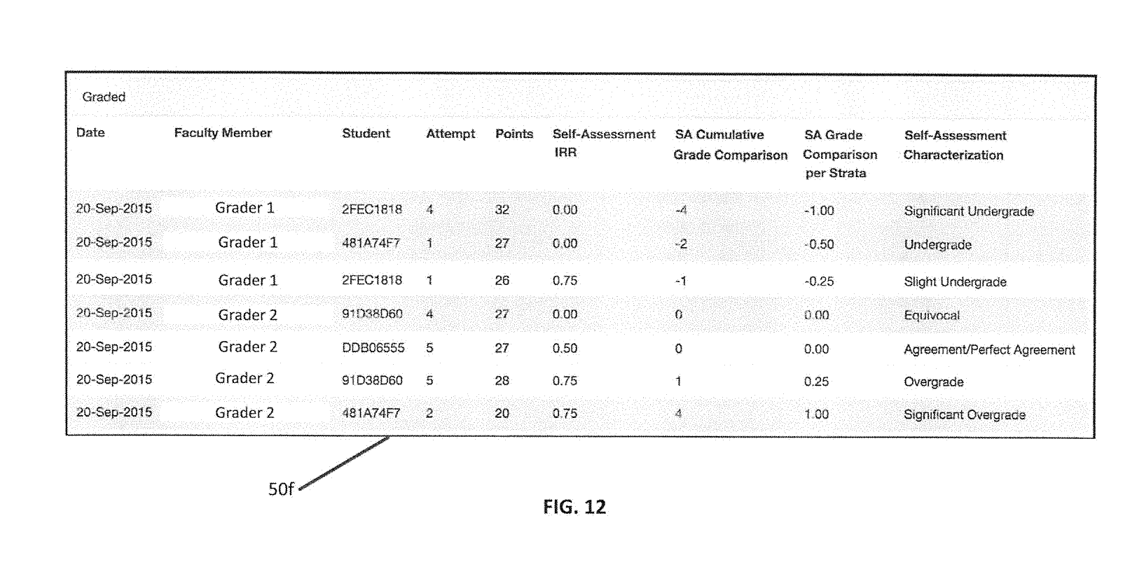

Methods, systems, and computer program products described herein may include the subject of the assessment performing their own self-assessment (FIG. 1, block 400). The self-assessments for all subjects who encounter the assessment may be recorded with the characterization determined. This may allow the program to evaluate how well a student performs self-assessments as a method of evaluating effectiveness of the assessment. For example, the prior grader comparison discussed with respect to FIG. 9 may be performed using with the student's assessment as one of the grader assessments, and the student as the grader. FIG. 12 illustrates a user interface 50f displaying a comparison table which may be used to compare one or more students' self-assessment according to various embodiments described herein. As illustrated in FIG. 12, a list of all of the students and their self-assessment characterization for one assessment is shown with significant overgrades, significant undergrades and equivocal characterizations denoting specific students who are not performing the self assessment well.

Grade Calibration Report

Methods, systems, and computer program products described herein may include the generation of a grade calibration report (FIG. 1, block 500). Such a report may compare the results of assessment comparisons performed across multiple graders. For example, the results of the comparisons between grader 1 and grader 2, grader 1 and grader 3, and grader 2 and grader 3 may be reported. FIG. 13 illustrates a user interface 50g displaying an example of a grade calibration report for a particular grader according to various embodiments described herein. In the example of FIG. 13, the grader 1 qualified 15 out of 20 attempts. In most of the disqualifications the grader registered as “Significant Overgrade.” That means that the grader grades easier than the reference or definitive graders. This allows the graders to help calibrate the grader for subsequent assessments. In some embodiments, disqualification may be related to the number of steps in which they are in agreement with a reference grader (e.g., the Inter-Rater Reliability column in FIG. 13). In some embodiments, when a threshold is set, a grader may be disqualified when the grader is below the threshold relative to the definitive grader. A report such as the one in FIG. 13 may show the character of the calibration (e.g., under or overgrade) when a grader is disqualified. In a “rule-of-twos” model, a grader can be disqualified when two of the three graders pass the student and the third fails the student. Or, when two fail the student and the third passes.

Graders who are disqualified from the assessment may receive a notice reporting their percentage of qualification and the rubric steps in the rubrics for which they were disqualified. The definitive grader may set a threshold of agreement for a grader to be considered for the next assessment. The goal of recording faculty grading calibration is to increase the validity of the assessment of the rubric.

Final Grade Calculation

Methods, systems, and computer program products described herein may include the calculation of a final grade (FIG. 1, block 600). The final grade may be based on the grader/rater assessments as well as the extent to which (or if) the grader/rater assessments agree with one another. In some embodiments, if two grader/rater assessments are in agreement with one another (i.e. meet the designated agreement threshold), the rubric step/strata of the two assessments may be averaged together to form the final grade. As will be understood, two assessments that meet the agreement threshold may not agree on all strata. As such, the two strata may match on some rubric steps but have different results for other rubric steps. The final strata calculation may average those rubric steps for which the grader/rater assessments do not match but the overall assessments meet the agreement threshold. Since the points for the strata may not be contiguous, the average may be rounded up, or down, to the closest discrete value for the strata to determine the final strata calculation. In some embodiments, if there is an extreme disagreement in a particular rubric step between multiple graders (e.g., one grader rates performance as very high, and one grader rates performance as very low) remediation may be taken for that particular score rather than simply averaging the results. Such a disagreement may indicate that the underlying element was confusing or subject to subjective analysis. For these elements, manual intervention may be taken by the graders to agree upon the correct grade.

If the two assessments are not in agreement (e.g. do not meet the designated agreement threshold) other types of remediation may be taken. For example, when one grader/rater is designated as a senior grader, the less senior grader's assessment may be dropped. In some embodiments, the disagreement may cause an indication to be sent that further analysis of the assessments is needed.

In some embodiments, the final grade calculation may be further adjusted based on a self assessment by the student. The student's self-assessment may be compared to the final grade calculation determined from the one or more grader/rater assessments. The comparison may be made in a same or similar manner as described herein with respect to the inter grader/rater assessment comparison. The final grade calculation may be further adjusted based on how closely the student's self assessment agrees with the final grade calculation. That is to say that the final grade calculation may be adjusted upwards or downwards based on whether the student's self assessment matches that of the grader/rater(s).

Since the goal for characterization of student self-assessment is to properly evaluate their work, a rule of the assessment can augment the student score when in agreement and can reduce the score when not in agreement (e.g., self assessments which are rated as significantly overgraded, undergraded or equivocal). For example, ifa student performs poorly on the skill, but recognizes (agreement) that they performed poorly (but passed), then the final score can be augmented by a certain number of points or a percentage. As the counter example, if the student performs well on the skill but undergrades, a certain number of points or a certain percentage can be discounted from the score. The goal is to encourage proper self-assessment reporting.

Similarly, if a student fails an assessment but recognizes the performance as failing, then a smaller reduction of potential points or percentage may be awarded for the subsequent retake.

Utilizing the method of the present invention, there are multiple scenarios that can be encountered with respect to the use of student self-assessment as compared to one or more grader assessments.

Scenario 1: Subject Self-Assessment with Single Grader

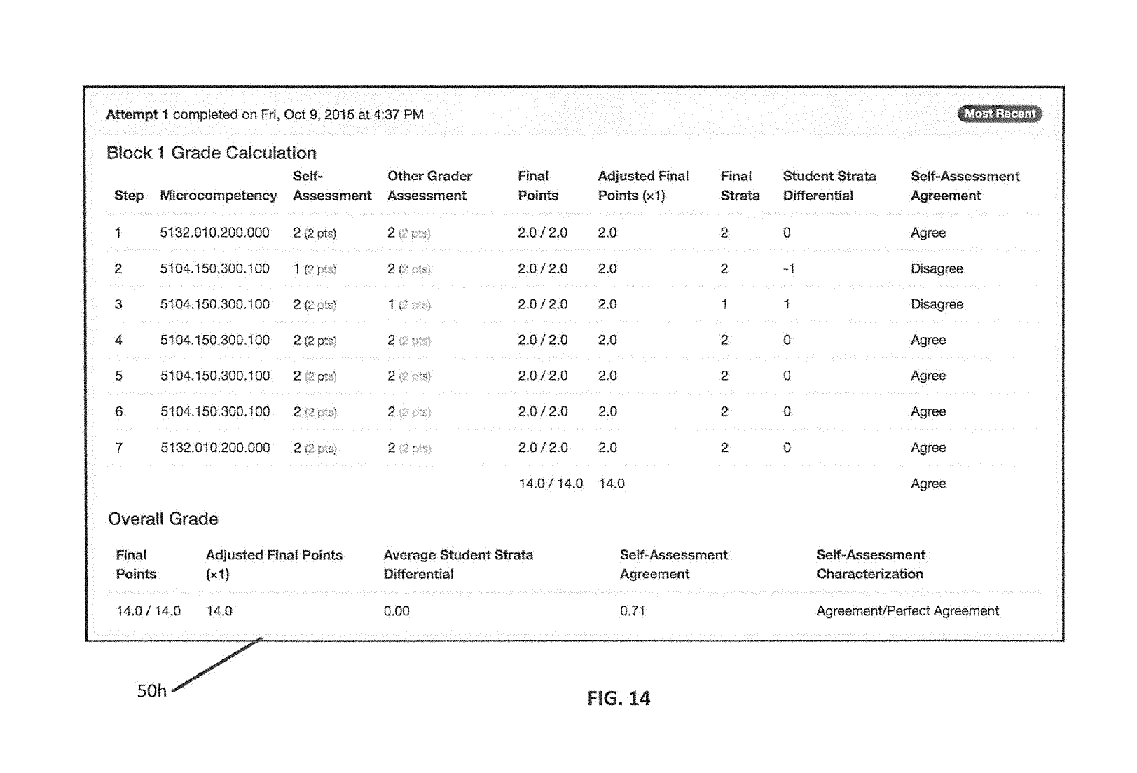

In this scenario, there are two graders, the subject who performs a self-assessment and a single grader to evaluate performance. The self-assessment may be automatically determined to be in the role as grader 1 and the single grader may be automatically determined as the role as grader 2 for comparison. FIG. 14 illustrates a user interface 50h displaying an example of a scenario where a student self-assessment is being compared to a single grader according to various embodiments described herein. In the example of FIG. 14, there are 7 rubric steps and 3 strata (Strata 0 plus Strata 1 and Strata 2). The points are irrelevant for this example. In some embodiments, the threshold for agreement is also irrelevant because the single grader cannot be disqualified. As illustrated in the example of FIG. 14, the subject chose strata 1 for step 2 which is lower than the grader choice of strata 2. The subject chose strata 2 for step 3 which is higher than the grader choice of strata 1. A comparison table is generated subtracting the self-assessment from the grader. The strata differential for rubric step 2 is −1 and for rubric step 3 is +1, yielding a cumulative assessment differential quotient of 0. Thus the subject grading characterization is “Agreement.”

Scenario 2: Subject Self-Assessment with 2-Grader Process (Grader 1 and Reference Grader 2)

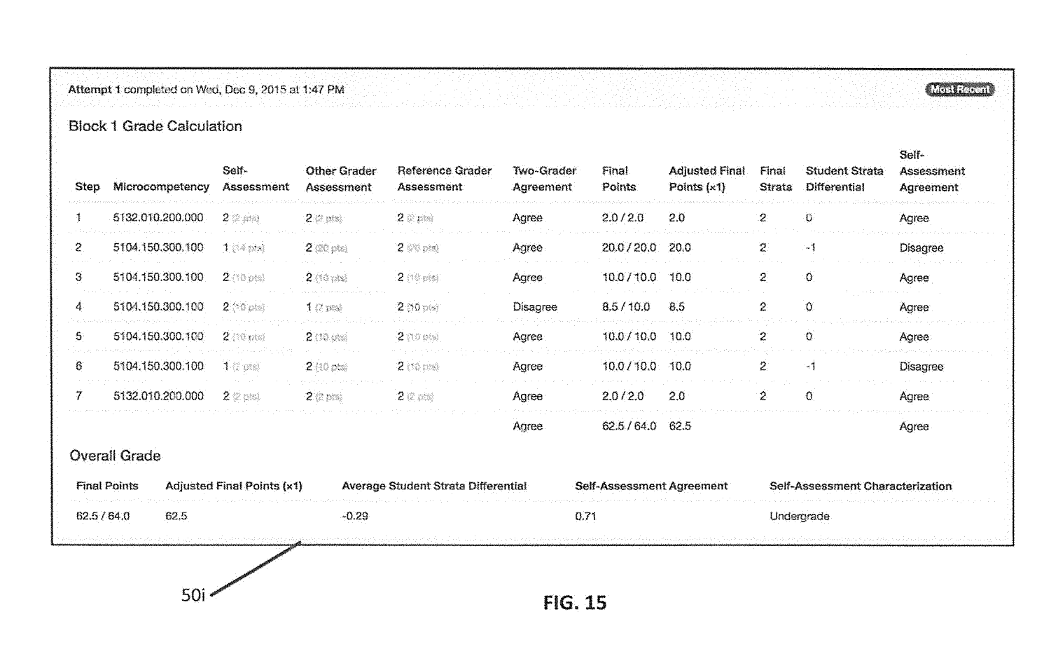

In this scenario, the subject performs a self-assessment first but the results of this assessment are stored for comparison to the final grade that will be generated from undefended evaluations by two graders. FIG. 15 illustrates a user interface 50i displaying an example of a scenario where a student self-assessment is being compared to two assessments from two graders according to various embodiments described herein. In the example of FIG. 15, there are 7 rubric steps in the rubric and the pre-determined threshold for this assessment was set at 57% requiring that 4 of the 7 steps be in agreement. In the example of FIG. 15, the grader 1 evaluated the subject, and then the grader 2 evaluated the subject. As illustrated in FIG. 15, the two graders agree on all rubric steps except for rubric step 4 where the Grader 1 used strata 1 and Grader 2 used strata 2. An inter-rater comparison is set up. The graders agreed on 6 of the 7 rubric steps, thus meeting the pre-determined threshold for agreement. The strata differential is calculated for each rubric step. The cumulative assessment differential quotient is calculated as −0.17 which is characterized as “slight undergrade” for grader 1. This indicates that he/she was a slightly harder grader than the reference grader 2.

Because there was agreement between the grader 1 and grader 2, the points of the two graders are averaged for all rubric steps, yielding an 8.5 points for rubric step 4 (e.g., 7 points for grader 1 and 10 points for grader 2). The 8.5 is rounded up to the closest point value of the available strata which is 10 points which is associated with strata 2. This means that the final strata will be determined to be strata 2.

An inter-rater comparison is now set up between the final calculated strata and the stored subject self-assessment. The subject chose strata 1 for rubric step 2 and rubric step 6 and the final strata for those rubric steps was strata 2. The strata differential for each rubric step is calculated, yielding −1 for both step 2 and step 6. The cumulative assessment differential quotient is calculated to be −0.29 which is less than −0.25 yielding a characterization of “undergrade.” This indicates that the student was more pessimistic about his/her performance than the graders' ultimate determination.

Scenario 3: Subject Self-Assessment with 2-Grader Process (Graderl and Reference Grader 2) Plus Appeal (Grader 3 Definitive Grader)

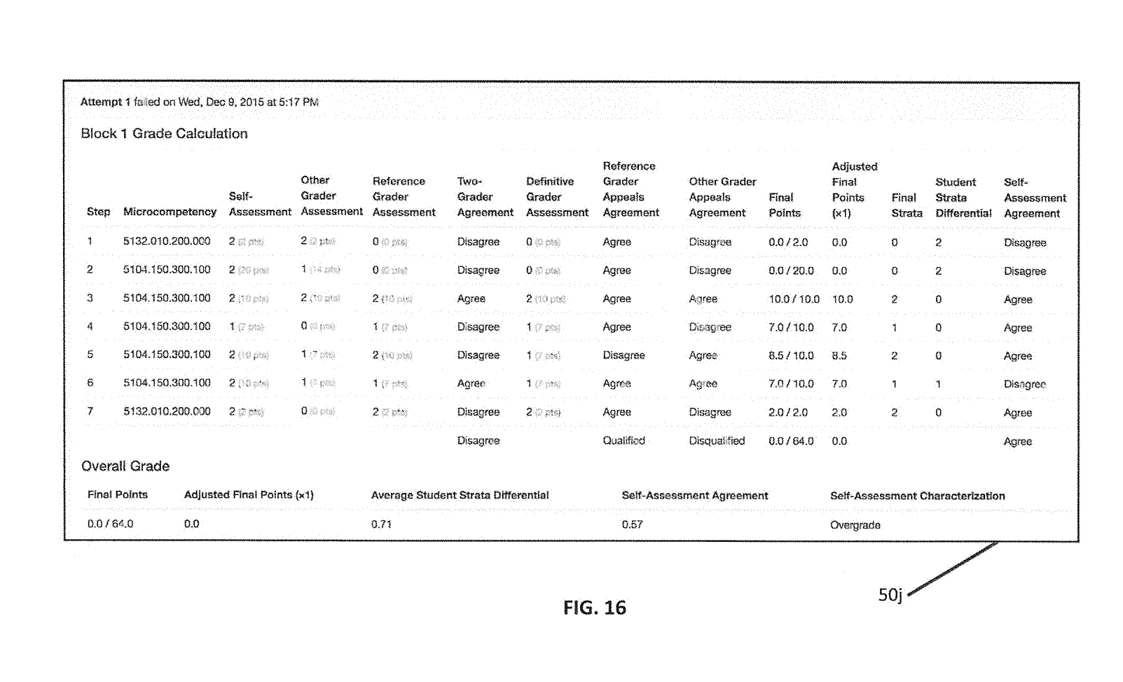

In this scenario, the subject may perform a self-assessment which is stored for comparison with the eventual final strata. Grader 1 and grader 2 may each independently evaluate the subject using the rubric. An inter-rater comparison may be set up between grader 1 and grader 2. FIG. 16 illustrates a user interface 50j displaying an example of a scenario where a student self-assessment is being compared to two graders with an additional appeal utilizing a reference grader according to various embodiments described herein. In this example of FIG. 16, the two graders only agree on 2 of the 7 rubric steps, which is below the pre-determined threshold (e.g., 57%). In this scenario, a third independent grader may evaluate the subject, then inter-rater comparisons are created for grader 1 and grader 3, then for grader 2 and grader 3. In the example of FIG. 16, grader 1 and grader 3 only agree on three of the seven rubric steps, thus disqualifying grader 1. Grader 2 and grader 3 agree on six of the seven rubric steps, and both grader 2 and grader 3 qualify. The points for the rubric steps from grader 2 and grader 3 are averaged. Rubric step 5 yields an average of 8.5 points which is rounded up to the closest strata 2, which has a 10 point value.

A fourth inter-rater comparison may be created between the subject self-assessment and the final strata that were generated from the qualified grader 2 and grader 3. The strata differential from the subject self-assessment may be generated for all rubric steps and a cumulative assessment differential quotient of 0.71 is calculated. This quotient falls between 0.25 and 0.75 which is characterized as “overgrade.” This indicates that the student was more optimistic about his/her performance than the graders' ultimate determination.

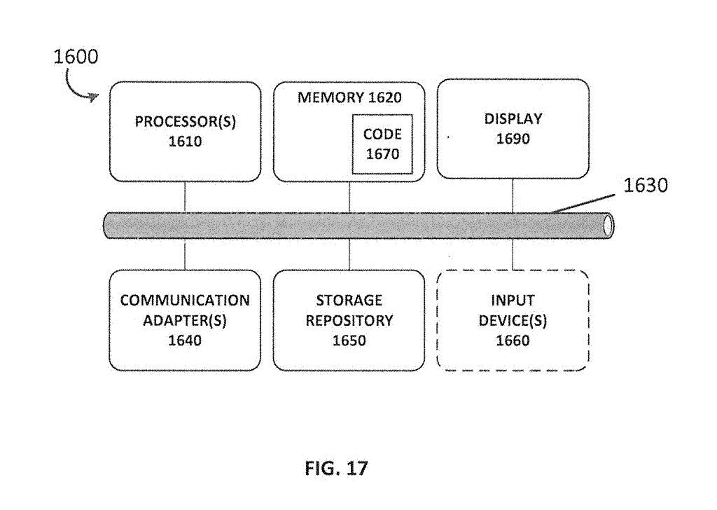

FIG. 17 is a block diagram of an assessment system 1600 according to some embodiments of the present invention. The assessment system 1600 may use hardware, software implemented with hardware, firmware, tangible computer-readable storage media having instructions stored thereon and/or a combination thereof, and may be implemented in one or more computer systems or other processing systems. The assessment system 1600 may also utilize a virtual instance of a computer. As such, the devices and methods described herein may be embodied in any combination of hardware and software.

As shown in FIG. 17, the assessment system 1600 may include one or more processors 1610 and memory 1620 coupled to an interconnect 1630. The interconnect 1630 may be an abstraction that represents any one or more separate physical buses, point to point connections, or both connected by appropriate bridges, adapters, or controllers. The interconnect 1630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire.”

The processor(s) 1610 may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks. The processor 1610 may be configured to execute computer program instructions from the memory 1620 to perform some or all of the operations and methods for one or more of the embodiments disclosed herein.

The assessment system 1600 may also include one or more communication adapters 1640 that may communicate with other communication devices and/or one or more networks, including any conventional, public and/or private, real and/or virtual, wired and/or wireless network, including the Internet. The communication adapters 1640 may include a communication interface and may be used to transfer information in the form of signals between the assessment system 1600 and another computer system or a network (e.g., the Internet). The communication adapters 1640 may include a modem, a network interface (such as an Ethernet card), a wireless interface, a radio interface, a communications port, a PCMCIA slot and card, or the like. These components may be conventional components, such as those used in many conventional computing devices, and their functionality, with respect to conventional operations, is generally known to those skilled in the art.

The assessment system 1600 may further include memory 1620 which may contain program code 1670 configured to execute operations associated with the methods described herein. The memory 1620 may include removable and/or fixed non-volatile memory devices (such as but not limited to a hard disk drive, flash memory, and/or like devices that may store computer program instructions and data on computer-readable media), volatile memory devices (such as but not limited to random access memory), as well as virtual storage (such as but not limited to a RAM disk). The memory 1620 may also include systems and/or devices used for storage of the assessment system 1600.

The assessment system 1600 may also include on or more input device(s) 1660 such as, but not limited to, a mouse, keyboard, camera, and/or a microphone. The input device(s) 1660 may be accessible to the one or more processors 1610 via the system interconnect 1630 and may be operated by the program code 1670 resident in the memory 1620

The assessment system 1600 may also include a display 1690 capable of generating a display image, graphical user interface, and/or visual alert. The display 1690 may provide graphical user interfaces for receiving input, displaying intermediate operations/data, and/or exporting output of the methods described herein.

The assessment system 1600 may also include a storage repository 1650. The storage repository may be accessible to the processor 1610 via the system interconnect 1630 and may additionally store information associated with the assessment system 1600. For example, in some embodiments, the storage repository 1650 may contain accumulated applicant data, historical outcomes, and/or assessment model data as described herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A system for calibrating ratings for competency of a student, the system comprising:
a processor; and
a memory coupled to the processor and storing computer readable program code that when executed by the processor causes the processor to perform operations comprising:
generating a rubric for assessing the competency of the student, wherein the rubric comprises a plurality of rubric steps, each rubric step comprising strata that identify levels of performance associated with performing the rubric step;
receiving a first assessment from a first grader and a second assessment from a second grader, wherein the first assessment comprises first strata that assesses performance of the student, and wherein the second assessment comprises second strata that assess the performance of the student;
comparing the first assessment to the second assessment to generate a first differential between the first strata and the second strata;
calculating a final assessment of the student comprising final strata based on an average of the first strata and the second strata responsive to determining a number of rubric steps for which the first and second strata are in agreement is greater than an agreement threshold;
receiving a self assessment from the student, wherein the self assessment comprises third strata that assesses the performance of the student;
comparing the self assessment to the final assessment to generate a second differential between the final strata and the third strata; and
adjusting the final assessment of the student based on the second differential.

2. A system for calibrating ratings for competency of a student, the system comprising:
a processor; and
a memory coupled to the processor and storing computer readable program code that when executed by the processor causes the processor to perform operations comprising:
generating a rubric for assessing the competency of the student;
receiving a plurality of assessments of the competency of the student based on the rubric, wherein the plurality of assessments comprise one or more assessments from a plurality of different graders;
creating an assessment comparison between respective ones of the plurality of assessments;
based on the assessment comparison, creating characterizations of the plurality of assessments; and
calculating a final assessment of the competency of the student based on the characterizations of the plurality of assessments.

3. (canceled)

4. The system of claim 2, wherein the plurality of assessments comprise a self assessment of the competency of the student that is generated by the student.

5. The system of claim 4, wherein the operations further comprise:
creating a characterization of the self assessment based on the assessment comparison; and
further calculating the final assessment of the competency of the student based on the characterization of the self assessment.

6. The system of claim 5, wherein further calculating the final assessment of the competency of the student based on the characterization of the self assessment comprises:
calculating a differential between the final assessment and the self assessment for respective rubric steps of the rubric;
calculating a number of the rubric steps for which the final assessment and the self assessment are in agreement;
comparing the number of the rubric steps for which the final assessment and the self assessment are in agreement to an agreement threshold to determine an assessment agreement; and
modifying the final assessment of the competency of the student based on the assessment agreement.

7. The system of claim 6, wherein modifying the final assessment of the competency of the student based on the assessment agreement comprises increasing the final assessment responsive to a determination that the number of the rubric steps for which the final assessment and the self assessment are in agreement is greater than the agreement threshold.

8. The system of claim 6, wherein modifying the final assessment of the competency of the student based on the assessment agreement comprises decreasing the final assessment responsive to a determination that the number of the rubric steps for which the final assessment and the self assessment are in agreement is less than the agreement threshold.

9. The system of claim 2, wherein generating the rubric for assessing the competency of the student comprises:
creating a plurality of rubric blocks associated with assessing the competency of the student;
for each of the plurality of rubric blocks, creating one or more rubric steps associated with performing the rubric block;
for respective ones of the one or more rubric steps, creating strata that identify levels of performance associated with performing the rubric step;
establishing a number of graders to be used in evaluating performance of the rubric; and
establishing an agreement threshold for the rubric that defines a number of rubric steps for which the number of graders must select the same strata so as to be considered as in agreement.

10. The system of claim 9, wherein creating the assessment comparison between respective ones of the plurality of assessments comprises:
selecting at least two assessments of the plurality of assessments;
calculating a differential between the at least two assessments for respective rubric steps of the rubric;
calculating a number of rubric steps for which the at least two assessments are in agreement; and
comparing the number of rubric steps for which the at least two assessments are in agreement to the agreement threshold to determine an assessment agreement.

11. The system of claim 10, wherein the at least two assessments are in agreement if the number of rubric steps for which the at least two assessments are in agreement is greater than the agreement threshold.

12. The system of claim 10, wherein creating the characterizations of the plurality of assessments comprises:
calculating a cumulative assessment differential based on a sum of the respective differentials of the at least two assessments; and
calculating a cumulative assessment differential quotient based on the cumulative assessment differential divided by the number of rubric steps.

13. The system of claim 12, wherein creating the characterizations of the plurality of assessments further comprises:
responsive to determining the number of rubric steps for which the at least two assessments are in agreement is greater than the agreement threshold, classifying the at least two assessments as being in agreement if the cumulative assessment differential is zero.

14. (canceled)

15. The system of claim 10, wherein calculating the final assessment of the competency of the student based on the characterizations of the plurality of assessments comprises excluding one of the at least two assessments of the plurality of assessments from being used for calculation of the final assessment responsive to determining the number of rubric steps for which the at least two assessments are in agreement is less than the agreement threshold.

16. A method for calibrating ratings for competency of a student comprising:
generating a rubric for assessing the competency of the student;
receiving a plurality of assessments of the competency of the student based on the rubric, wherein the plurality of assessments comprise one or more assessments from a plurality of different graders;
creating an assessment comparison between respective ones of the plurality of assessments;
based on the assessment comparison, creating characterizations of the plurality of assessments; and
calculating a final assessment of the competency of the student based on the characterizations of the plurality of assessments.

17. (canceled)

18. The method of claim 16, wherein the plurality of assessments comprise a self assessment of the competency of the student that is generated by the student.

19. The method of claim 18, further comprising:
creating a characterization of the self assessment based on the assessment comparison; and
further calculating the final assessment of the competency of the student based on the characterization of the self assessment.

20. The method of claim 19, wherein further calculating the final assessment of the competency of the student based on the characterization of the self assessment comprises:
calculating a differential between the final assessment and the self assessment for respective rubric steps of the rubric;
calculating a number of the rubric steps for which the final assessment and the self assessment are in agreement;
comparing the number of the rubric steps for which the final assessment and the self assessment are in agreement to an agreement threshold to determine an assessment agreement; and
modifying the final assessment of the competency of the student based on the assessment agreement.

21-22. (canceled)

23. The method of claim 16, wherein generating the rubric for assessing the competency of the student comprises:
creating a plurality of rubric blocks associated with assessing the competency of the student;
for each of the plurality of rubric blocks, creating one or more rubric steps associated with performing the rubric block;
for respective ones of the one or more rubric steps, creating strata that identify levels of performance associated with performing the rubric step;
establishing a number of graders to be used in evaluating performance of the rubric; and
establishing an agreement threshold for the rubric that defines a number of rubric steps for which the number of graders must select the same strata so as to be considered as in agreement.

24. The method of claim 23, wherein creating the assessment comparison between respective ones of the plurality of assessments comprises:
selecting at least two assessments of the plurality of assessments;
calculating a differential between the at least two assessments for respective rubric steps of the rubric;
calculating a number of rubric steps for which the at least two assessments are in agreement; and
comparing the number of rubric steps for which the at least two assessments are in agreement to the agreement threshold to determine an assessment agreement.

25. The method of claim 24, wherein the at least two assessments are in agreement if the number of rubric steps for which the at least two assessments are in agreement is greater than the agreement threshold.

26-30. (canceled)
